(19) United States
(12) Patent Application Publication
(10) Pub. No.: US 2002/0035619 A1
(43) Pub. Date: Mar. 21, 2002

(54) Apparatus and method for producing contextually marked-up electronic content

(76) Inventors: Carter D. Dougherty, Oakland, CA (US); Adam Kurland, San Carlos, CA (US)

Correspondence Address: COOLEY GODWARD, LLP, 3000 EL CAMINO REAL, 5 PALO ALTO SQUARE, PALO ALTO, CA, 94306, US

(21) Appl. No.: 09/921,647

(22) Filed: Aug. 2, 2001

Related U.S. Application Data
(63) Continuation-in-part of application No. 09/631,439, filed on Aug. 2, 2000.

(51) Int. Cl. G06F 15/16

(52) U.S. Cl. 709/219; 709/246

(57) ABSTRACT

A method of providing contextual marked-up information includes receiving a request from a user for an information resource. The information resource is retrieved. Data in the information resource is converted into inserted user-selectable objects, thereby rendering a converted information resource. The converted information resource is provided to the user. By selecting an inserted user-selectable object, the user secures additional information regarding the inserted user-selectable object. The inserted user-selectable objects augment the pre-existing user-selectable objects that may exist in an information resource. The inserted user-selectable objects are supplied without modifying software at the source of the information resource.

### BRIEF DESCRIPTION OF THE INVENTION

This invention relates to systems and methods for integrating electronic content. More particularly, the systems and methods of the invention provide techniques for supplementing electronic content to automatically include links to related content.

### BACKGROUND OF THE INVENTION

On the Internet, there are many websites that are devoted to the provision of information, and there are many websites that sell products or services. Many information providers include links to merchant sites in the form of banner advertisements or recommendations. Information providers then receive compensation for click-throughs to a site or receive a commission on subsequent sales at the site.

Also, there are many websites that are both merchant sites and content providers. While reviewing the content, the user is typically provided with the opportunity to buy related merchandise. For example, while reading a movie review on a website, the user may be provided with a link to buy a video copy of the movie, or to purchase movie tickets for that movie.

Many content providers want to expand their offerings to include the sale of merchandise, and many merchant sites want to provide content to increase commerce on their sites, but expanding into these new avenues can be challenging. Other content providers are not interested in merchandise sales, but are interested in improving the delivery of information to their customers. Improved information delivery is critical in developing a client following. A strong client following is important in both a subscription-based service and in an advertising-based service. The quality of the delivered information is a function of the relevance of the information to the user. There is an ongoing need to provide the most relevant content, with links to the most relevant related information. It is also important to deliver the information in an intuitive format that allows a customer to understand the information and its potential relevance.

Thus, there is an ongoing need for techniques for integrating content and commerce web sites. In addition, there is an ongoing need for improved techniques for integrating related content and presenting that information in an effective format.

### SUMMARY OF THE INVENTION

The invention includes a method of providing contextually marked-up information. The method includes receiving a request from a user for an information resource. The information resource is retrieved. Data in the information resource is converted into inserted user-selectable objects, thereby rendering a converted information resource. The converted information resource is provided to the user. By selecting an inserted user-selectable object, the user secures additional information regarding the inserted user-selectable object. The inserted user-selectable objects augment the pre-existing user-selectable objects that may exist in an information resource. The inserted user-selectable objects are supplied without modifying software at the source of the information resource.

The invention includes a computer readable medium to direct a computer to function in a specified manner. There are instructions to process a request from a user for an information resource. Instructions are used to retrieve the information resource. Additional instructions convert data in the information resource into inserted user-selectable objects, thereby rendering a converted information resource. Instructions then provide the converted information resource to the user.

### DESCRIPTION OF THE DRAWINGS

Embodiments of the invention will now be described more fully with reference to the accompanying drawings, in which:

FIG. 1 is a schematic representation of one embodiment of a system according to the invention.

FIG. 2 is an example of an information source with user selectable objects and inserted user selectable objects.

FIG. 3 is a schematic representation of the contextual mark-up system of FIG. 1.

FIG. 4 is a state diagram of the markup engine of FIG. 3.

FIG. 5 is schematic representation of the contextual commerce module of the commerce website of FIG. 1.

FIG. 6 is a schematic representation of architecture for providing markup of selected portions of an information resource.

FIG. 7 is a state diagram for an exemplary recognizer module for use in the architecture of FIG. 6.

FIG. 8 illustrates a content rating technique that may be used in accordance with an embodiment of the invention.

FIG. 9 illustrates a technique for searching rated content in accordance with an embodiment of the invention.

FIG. 10 illustrates rated content search results that may be produced in accordance with an embodiment of the invention.

FIG. 11 illustrates a content summary technique utilized in accordance with an embodiment of the invention.

Identical reference numerals in the different figures refer to identical components.

### DETAILED DESCRIPTION OF THE INVENTION

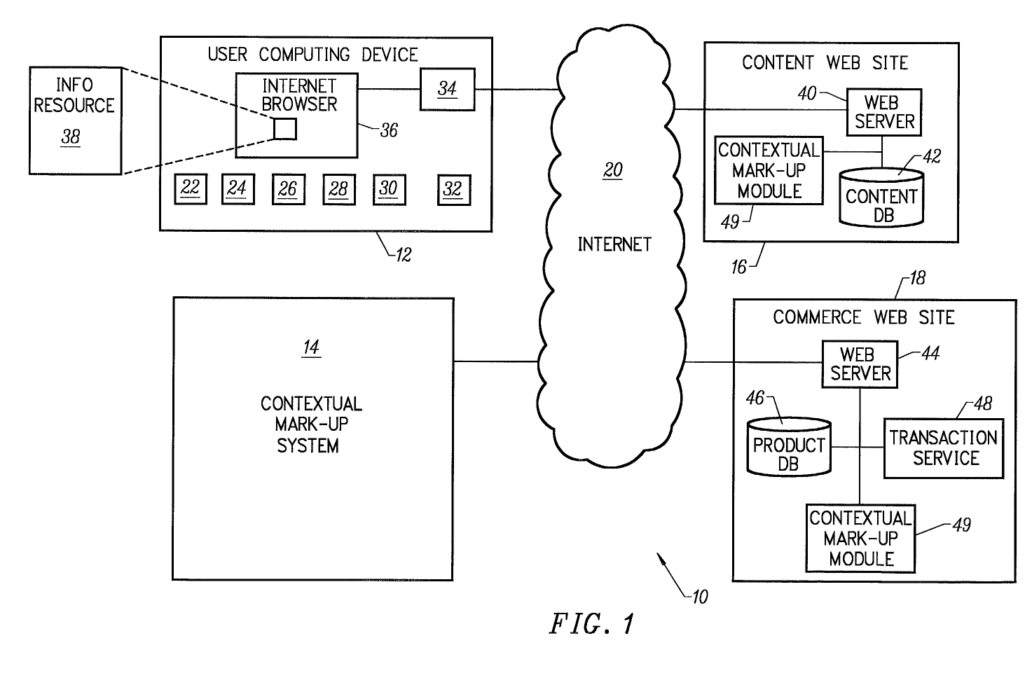

A schematic representation of one embodiment of a system 10 according to the invention is shown in FIG. 1. The system 10 generally comprises a computing device 12, a contextual mark-up system 14, a content web site 16 and a commerce web site 18. The computing device 12, the contextual mark-up system 14, the content website 16 and the commerce website 18 are able to exchange information over the Internet 20, typically using the hypertext transfer protocol. The content web site 16 and the commerce web site 18 are representative of multiple sites of this character that may be accessed in accordance with the invention, even though these additional sites are not depicted in FIG. 1.

The computing device 12 is typically a conventional personal computer with a microprocessor 22, random access memory 24, and a data storage device, such as a hard disc drive 26. In addition, the computing device 12 may include a computer monitor 28, keyboard 30, a pointing device 32, such as a mouse, and an Internet access device 34, such as a dial-up, DSL or cable modem or a network connection to a local area network that provides Internet access. It will however be appreciated that many alternative computing devices could be used in the systems and methods of the invention, including but not limited to personal digital assistants, hand-held computers, cellular telephones, interactive television systems, public access kiosks, and the like.

The illustrated computing device runs an operating system, such as Microsoft Windows, and includes an Internet browser 36, such as Microsoft internet Explorer or Netscape Navigator. The Internet browser 36 provides an interface that allows a user to access resources on the Internet 20. The Internet browser 36 accesses the Internet using the hypertext transfer protocol (HTTP), which is a common protocol used to carry requests from a browser to a web server and to transport information resources 38 from web servers back to the requesting browser. It will however be appreciated that the computing device may access the Internet in any number of ways using many different protocols. For example, a cellular telephone or portable digital assistant may access the Internet wirelessly using WAP (the Wireless Access Protocol) and a micro-browser displaying WML (wireless markup language) information resources.

The information resource 38 is typically a web page, which may include text, graphics, audio, video, executable scripts, and links to other web pages. The web page is typically coded in hypertext markup language (HTML), which includes tags that mark elements, such as text and graphics, to indicate how Web browsers should display these elements to the user, and to define how the web browser should respond to user actions.

The information resource 38 also usually includes one or more user-selectable objects that include a word, phrase, symbol, or image and link to a different location in the document or to a different information resource. The user-selectable nature of the object is normally identified to the user by virtue of the object being underlined and/or being in a different color and/or by varying the appearance of a cursor as it passes over the object. In HTML, such user-selectable objects are typically referred to as hyperlinks.

Typically, the user selects a user-selectable object by manipulating the pointing device 32 to move a cursor over the user-selectable device, and clicking (or double-clicking as the case may be) a button on the pointing device 32. The action associated with the user-selectable object is then taken by the web-browser, such as retrieving and presenting another information resource. Of course, the information resource also typically includes many objects that are not selectable in this manner, such as plain text. Also, there are other ways of selecting user-selectable objects, such as by moving to the desired user selectable object using a TAB key and then pressing the ENTER key, or by means of voice recognition and control.

The link included in the user-selectable object will often be in the form of a Uniform Resource Locator (URL). A URL is an address for a resource on the Internet, and is used by the Internet browser 36 to request and receive a corresponding information resource 38 when a user selects the user-selectable object. A URL specifies the protocol to be used in accessing the resource (such as HTTP: for a World Wide Web page or ftp: for an FTP site), the name of the server on which the resource resides (such as //www.biospace.com), and, optionally, the path to a resource (such as an HTML document or a file on that server).

For example, the HTML definition:

<a href=“http://www.biospace.com/press_release.html”>Click here for press releases</a> will display in a different color (typically blue) as: Click here for press releases and, if selected, will result in the browser requesting, receiving and presenting the html document press_release.hmtl from the www.biospace.com server, using the HTTP protocol.

In the present example, the Internet browser 36 differs from a standard Internet browser in that it is configured to route requests for particular information resources to the contextual mark-up system 14 instead of to the websites where these information resources are actually located. This function is achieved in Netscape Navigator and Internet Explorer by configuring the web browser using a JavaScript function. When the Internet browser 36 starts, it loads an autoconfiguration file containing the JavaScript function. Each time the user selects a user-selectable object (typically by clicking a link or typing in a URL), the Internet browser 36 uses the JavaScript function to determine if it should request the information resource directly or use a proxy server and, if using a proxy server, which proxy server it should use.

The autoconfiguration file can be stored anywhere that is accessible to the browser 36. For example, the autoconfiguration file can be kept on a web server, on a local network file system, or locally on of the computing device 12 (e.g. on the hard drive 26). Preferably the autoconfiguration file is stored on a web server, since this means that there is one copy of the autoconfiguration file that can be updated easily for all users. In the illustrated embodiment, the autoconfiguration file is stored on the web server of the contextual mark-up system 14. Then all that is required at the computing device 12 is that the location of the autoconfiguration file (the URL) be entered into the Automatic Proxy Configuration field within the browser. An example of a Netscape Navigator configuration file is:

```
function FindProxyForURL(url, host)
{
  if (url.substring(O, 5) == “http:” &&
    (host == “164.195.100.11” ||
    dnsDomainIs(host, “.nih.gov”)))
    return “PROXY 192.168.11.39:8088; DIRECT”;
  else
    return “DIRECT”;
}
```

This JavaScript function functions as follows: if the browser is making an HTTP request and this request is for a resource at IP address 164.195.100.11 (the U.S. Patent Database) or to a web address ending in nih.gov (the host of the National Library of Medicine's PubMed services) then the browser sends the request to the proxy service at IP address 192.168.11.39 (the contextual mark-up system 14). If this test is not met, the browser requests the information resource directly. Finally, if the proxy service is requested but unavailable, the browser requests the information resource directly.

Also forming part of the invention are a content web site 16 and a commerce website 18. The content website typically includes a web server 40 and a collection of content information (content database 42). In use, the web server 40 receives a request from the Internet 20 to provide an information resource, retrieves the requested information resource from the content database 42, and transmits it to the contextual mark-up system 14. The contextual mark-up system 14 processes the information to produce inserted user-selectable objects, as discussed below. The content web site may also include a contextual mark-up module 49, the operation of which is discussed below.

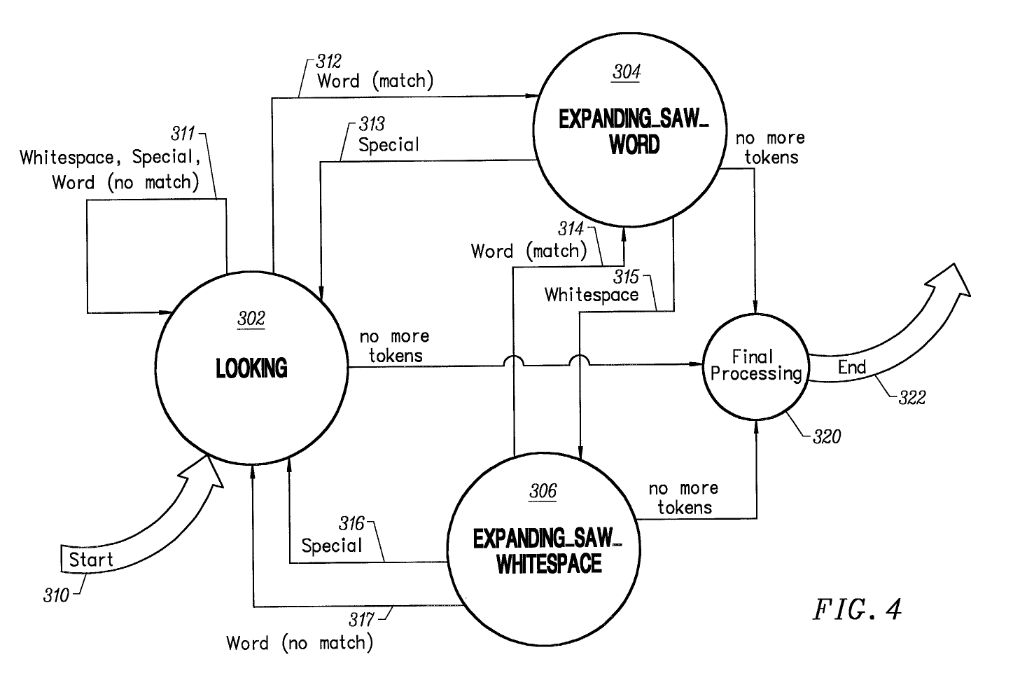

The commerce website 18 typically includes a web server 44, a product database 46, a transaction server 48 and a contextual commerce module 49. The transaction service 48 typically includes conventional commerce website features, such as virtual “shopping carts,” and product or service ordering using secure protocols such as HTTPS. In the illustrated embodiment of the invention, the commerce website 18 is conventional in nature with the exception of the contextual commerce module 49, which is described in more detail below with reference to FIG. 4.

Referring again to FIG. 1, in operation, a user at the computing device 12 starts an instance of the Internet browser 36. As it loads, the Internet browser 12 requests the auto-configuration file from a designated location. As previously indicated, the designated location may be a central location, which allows for easy updates to the auto-configuration file. Central locations of this type may include the content web site 16, the commerce web site 18, or the contextual mark-up system 14. Alternately, the auto-configuration file may be located on the computing device 12. Once loaded, the auto-configuration file configures the browser to route requests for certain information resources to the contextual mark-up system 14.

The user then generates a request for an information resource 38 (e.g., a web page) contained in a first collection of information resources (e.g., content database 42). This is typically done by the user selecting a hypertext link using the pointing device 32 or by entering a URL in the Internet browser's address bar. The Internet browser 36 reviews the request for the information resource to determine whether it has been requested from the site addresses defined in the browser auto-configuration file. If so, the browser passes the request to the contextual mark-up system 14, which is the proxy service that is defined in the auto-configuration file.

The request for the information resource is received by the contextual mark-up system 14, which in turn requests the information resource from the content website 16. In the request sent from the contextual mark-up system 14, the return address is defined as the address of the contextual mark-up system 14, not the computing device 12. The web server 40 of the content website 16 receives the request from the contextual mark-up system 14 and retrieves the requested information resource from the content database 42. The web server 40 then transmits the requested information resource to the contextual mark-up system 14. At the contextual mark-up system 14, selected data contained in the information resource is converted into inserted user-selectable objects, thereby to create a converted information resource. The converted information resource is sometimes referred to as a contextual mark-up information resource. In accordance with the invention, the user-selectable objects originally in the information resource are supplemented with inserted user-selectable objects. In other words, the original hypertext links in the information source are supplemented with additional hypertext links associated with selected keywords or concepts in the information source.

Typically, the data converted are text words or phrases (referred to hereafter as “keyphrases”) that are of potential particular significance to the user. In other words, the keyphrases are pre-selected terms that if present in the retrieved information will be highlighted as user-selectable objects. For example, if the content collection was a medical database, an article describing surgical procedures might include the phrase “carpal tunnel.” A database of medical equipment for sale might include an endoscope for use in carpal tunnel surgery. The description or title of the endoscope will probably include the phrase “carpal tunnel” and thus this is a logical keyphrase to convert into an inserted user-selectable object.

In one embodiment, the inserted user-selectable objects corresponding to the keyphrases are hyperlinks. The hyperlinks include the original text of the keyphrase and a URL. In some embodiments, the URL simply specifies a web site that is related to the keyphrase. In other embodiments, the URL specifies a web site and a keyphrase, thereby allowing additional processing at the specified web site. For example, the URL may include an identifier of the keyphrase, which may be the keyphrase itself, but is typically a numerical value (a keyphrase ID) that can be used to identify the keyphrase in a table of numerical values vs. keyphrases. An example of such a hyperlink is as follows:

<A HREF=“https://www.domain.com/lookup?phrasekey=16”
Target=“mall”><font color=“#007700”>test tube</font></A>

This hyperlink includes the keyphrase “test tube” and its corresponding keyphrase ID “16”. The color of the font used to display the hyperlinked keyphrase is green (font color=#007700), which is different from the conventional blue color that is used to represent hyperlinks already included in the information resource. The use of a different color allows the user to differentiate between user-selectable objects that define pre-existing navigation paths or actions, and inserted user-selectable objects that have been supplied by the contextual mark-up system 14.

Once the conversion of the information resource is completed at the contextual commerce site, the converted information resource or contextual mark-up information resource is transmitted to the computing device 12. The Internet browser 36 receives and displays the information resource 38 in accordance with the definitions encoded in the information resource. In particular, the keyphrases are displayed to the user as inserted user-selectable objects. These objects are presented in such a manner as to indicate that they represent selectable links, typically by displaying the keyphrases in a different color, by underlining them, and/or by changing the appearance of the cursor as it passes over the keyphrases.

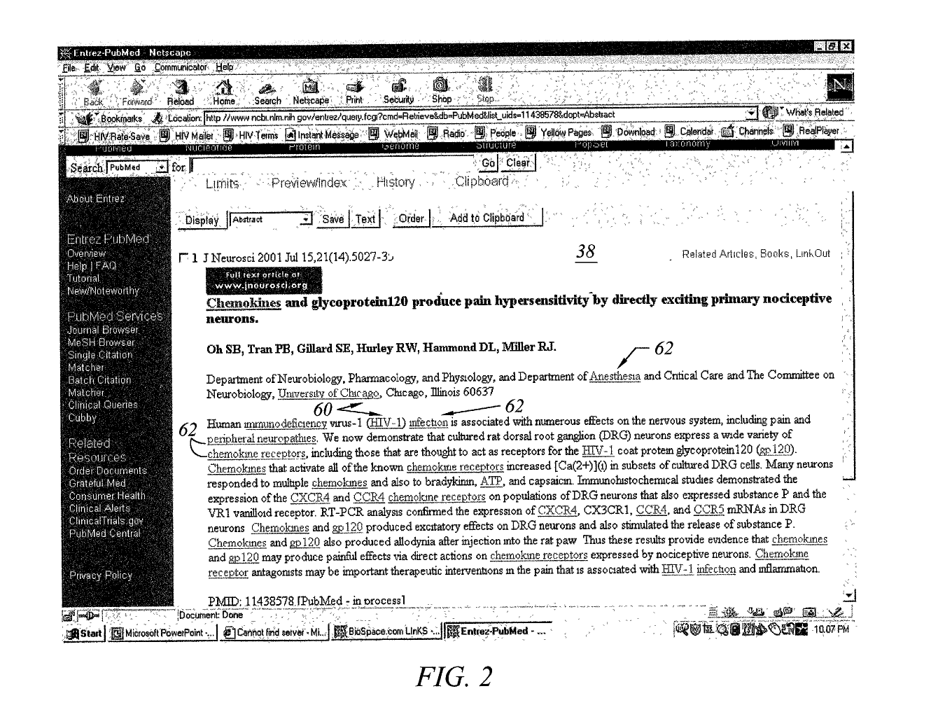

FIG. 2 illustrates an example of an information resource 38 returned in response to a query. The information resource 38 is in the form a scientific article. Some of the content in the article was originally marked with user-selectable objects, for example links 60. These original hypertext links were supplied by the source of the content. However, in accordance with the invention, inserted user-selectable objects 62 also appear in the information resource. These inserted objects 62 were supplied by the contextual mark-up system 14, not the originating site. Thus, in accordance with the invention, the original information resource 38 is further annotated with additional links. Different techniques for selecting additional links for the information resource 38 are discussed below.

The user then peruses the information resource at her leisure, and is free to take the usual actions associated with the information resource. For example, the user may print the information resource, save it, or navigate away from it in a conventional manner. However, should the user select one of the user-selectable objects (the hyperlinked keyphrases in the example), the Internet browser will direct the user to the specified web site. Recall that the inserted user-selectable object may specify a web site or it may specify a web site plus the keyphrase. In the event that the inserted user-selectable object simply specifies a web site, the user is directed to the web site that is related to the keyphrase. In the event that the user-selectable object specifies a web site plus a keyphrase, the keyphrase is further processed at the web site when the web site is provisioned in accordance with the invention. In this case, the keyphrase is used in a search at the web site.

FIG. 1 illustrates a commerce web site 18 with a contextual mark-up module 49. The contextual mark-up module 49 may also form a part of the content web site 16. The contextual mark-up module 49 is used to process the keyphrase and initiate a search at the web site using the keyphrase. In one embodiment, an inserted user-selectable object directs the user to the commerce website 18. The keyphrase identifier is used to look up the keyphrase from a table of keyphrases versus keyphrase ID's (or the keyphrase itself is extracted directly from the URL), and a search is executed through the product database 46.

The results of the search are then returned to the computing device 12 and are presented to the user. Referring to the exemplary hyperlink above, a new window in the Internet browser 36 is opened in which to display the search results. This is done by use of the “target” command in the hyperlink. Further selections of user-selectable objects will display in the same window as the first, allowing the user to keep a convenient separation between the information resource and the returned search results.

The search results themselves are typically displayed as a summary list of records that correspond to products or services in the product database 46. The search results are ranked according to relevance, with records having the keyphrase in the title being displayed highest in the list, followed in descending order by records that have the highest number of keyphrase hits. The records in the list are displayed in summary form (normally by title), and are themselves user-selectable to provide links to the full records corresponding to the products or services located by the search.

When a user selects a user-selectable link in the search results, the record corresponding to that product is retrieved from the product database 14 and presented to the user via the computing device 12. The user is then presented with known commerce website options, such as the ability to put the product or service into an online shopping cart, or the option of proceeding to a secure online checkout where the user can consummate a commercial transaction involving the product or service. These commerce web site options are provided by the transaction service 48.

Typically, the commercial transaction is the placing of an order for the purchase of the product or service, but the transaction may be any other commercial transaction. For example, the commercial transaction may be the closing of a lease, the finalizing of a barter transaction, the placing of a bid in an online auction or group-buying scheme, or the signing of a commercial contract using a digital signature. It should be noted that the commerce web site 18 can either be a site run by a third party (i.e., not the actual provider of the product or service) or can be the website of the actual provider of the offered products or services. Activity at the content web site 16 is similar, but it generally does not involve a transaction service 48.

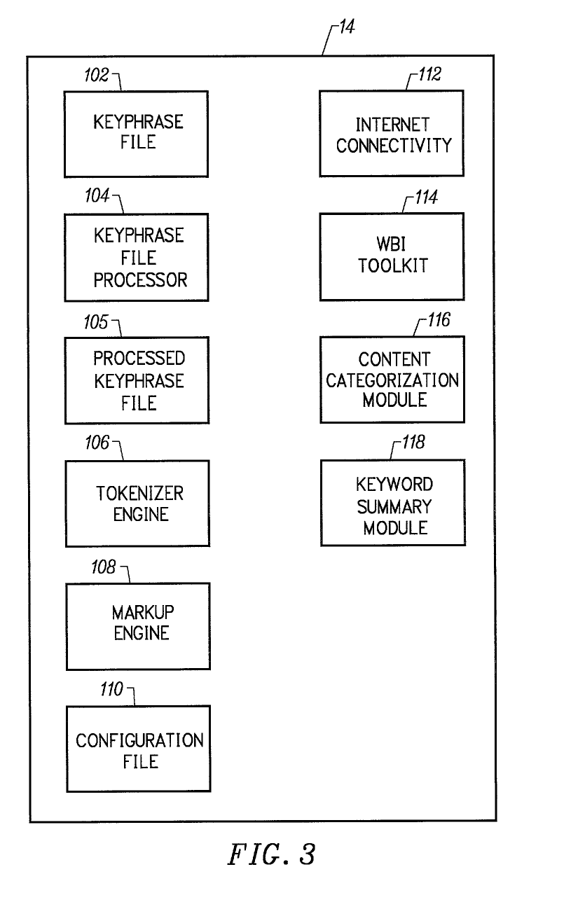

The general operation of the invention has been described. Attention now turns to the contextual mark-up system 14 that is used to facilitate the operations of the invention. The contextual mark-up system 14 is illustrated in more detail in FIG. 3. The contextual mark-up system 14 includes a keyphrase file 102, a keyphrase file processor 104, a tokenizer engine 106, a markup engine 108, and a configuration file 110. The contextual mark-up system 14 also includes an Internet connectivity module 112 and a WBI toolkit 114 that is used for creating and modifying the contextual mark-up system 14. Further, the contextual mark-up system 14 preferably includes a content categorization module 116 that is used to organize and rank the quality of content, as discussed below. Finally, the contextual mark-up system 114 includes a keyword summary module 118 to produce a document summary in the form of links that match predetermined criteria, as discussed below.

In one embodiment of the invention, the contextual mark-up system 14 is implemented as a series of Java applications in conjunction with the IBM WBI (“web intermediary”) framework. Intermediaries are computational entities that can be positioned along a data stream and are programmed to tailor, customize, personalize, or otherwise operate on data as they flow along the data stream. A typical use of an intermediary is to tailor Internet data for different devices (e.g. a personal digital assistant, cellphone etc.) according to the capabilities of that device. For example, an intermediary may tailor a web page so that it is displayed satisfactorily on a small monochrome screen of a portable computing device. The basic WBI framework can be tailored with relevant Java applications by a person skilled in the art to provide the functionality discussed below. It should be noted however that the invention is not limited to a particular framework, language, library, or other computing protocol or practice.

The keyphrase file 102 contains words or phrases that are going to be converted into the inserted user-selectable objects. The words or phrases for use in the keyphrase file 102 may be selected in any number of ways. For example, a keyphrase file 102 may be formed to specify words or phrases associated with a specific disease, a specific technical area, a specific area of the arts, and the like. In the case of a commerce web site, the keyphrase file 102 may contain words describing products associated with a disease or condition.

The generation of the keyphrase file 102 is typically done either by the people providing the contextual mark-up system 14 or by a group of prospective users, or by a combination of the two. For example, a scientist may include the words “micro-titer” and “umbilical” in the keyphrase file, if the scientist is interested in information, products and/or services that have descriptions including those words.

To maintain some control over the keyphrase file 102, the maintenance thereof is typically done by the provider of the contextual mark-up system 14, with the users of the service providing suggestions for new terms to include in the keyphrase file. Alternatively, the keyphrase file 102 could simply be a pre-existing glossary of terms in the field of interest, or could be generated automatically, e.g. by retrieving all nouns from an electronic dictionary of terms in the field of interest.

After generating the keyphrase file 102, the keyphrase file is processed by the keyphrase file processor 104 to generate a separate file that shall be referred to for convenience as the processed keyphrase file 105. In one embodiment, the keyphrase file processor 104 generates the processed keyphrase file 105 in two steps. First, each keyphrase is assigned an arbitrary and unique numeric value in ascending order. This numeric value is the keyphrase ID that was mentioned above with respect to the user-selectable link. For example, a (partially) processed keyphrase file 105 after this first stage of processing might include the following keyphrases and phrase ID's:

| Keyphrase | Phrase ID. |
|---|---|
| time | 1 |
| time for | 2 |
| all | 3 |
| to come to the front, | 4 |
| to come to the | 5 |
| country | 6 |

The second step in producing the processed keyphrase file 105 is to identify partial matches for keyphrases that are themselves not keyphrases. These partial matches are entered into the processed keyphrase file 105 with a zero phrase ID. So, for example, “to come to” is a partial match for “to come to the” and for “to come to the front” in the keyphrase file above, and thus is entered into the keyphrase file with a zero value keyphrase ID. On the other hand, “to come to the” is a partial match of “to come to the front” but is itself a keyphrase, and is thus not entered again into the keyphrase file.

This is accomplished as follows. Get a keyphrase from the (partially) processed keyphrase file 105. If it is one word long, get the next keyphrase. If the keyphrase is longer than one word, parse it into its component words. Define the first (leftmost) word of the parsed keyphrase as a partial keyphrase. Check if the partial keyphrase is in the (partially) processed keyphrase file 105. If it isn't, insert the partial keyphrase into the (partially) processed keyphrase file 105 with a zero-value keyphrase ID. If it is, then don't insert it into the (partially) processed keyphrase file 105 and add the next word of the parsed keyphrase to the partial keyphrase to update it. Check to see if the updated partial keyphrase is in the (partially) processed keyphrase file 105. If it isn't, insert the updated partial keyphrase into the (partially) processed keyphrase file 105 with a zero-value keyphrase ID. If it is, then don't insert it into the (partially) processed keyphrase file 105. Continue adding the next word of the keyphrase to the partial keyphrase and continue checking as above until the entire keyphrase has been checked. Repeat the procedure until all of the keyphrases have been processed in this manner to complete the generation of the processed keyphrase file 105.

The final processed keyphrase file 105 of our example will be as follows:

| Keyphrase | Phrase ID. |
|---|---|
| time | 1 |
| time for | 2 |
| all | 3 |
| to come to the front | 4 |
| to | 0 |
| to come | 0 |
| to come to | 0 |
| to come to the | 5 |
| country | 6 |

As will be described below, the inclusion of non-keyphrase partial matches with zero keyphrase ID's is done to permit the markup engine to recognize that it is analyzing a partial match of an actual keyphrase.

As mentioned previously, the markup engine 108 converts an information resource into a converted information resource. In the conversion process, data contained in the information resource is converted into inserted user-selectable objects. In the described example, the information object is a webpage including text; the conversion process converts plain text into hyperlinked text; and the converted webpage thus includes hyperlinked text that was not hyperlinked originally.

As will be described more fully below, the markup engine 108 receives “tokens” as input. This input is provided by the tokenizer engine 106, which converts the information resource (or part thereof) into tokens. The tokens are then passed one at a time to the markup engine 108 in response to a call from the markup engine 108. In one embodiment, there are three types of tokens: word, whitespace, and special, and they are defined as a consecutive sequence of characters all from the same character class. A “word” is defined as one or more consecutive characters in the range A-Z, a-z, 0-9, and the characters “/”, “−”, and “_”. A “whitespace” is one or more spaces, tabs, carriage-returns or linefeeds. A “Special” is one or more characters that are not in the above two classes. This would include periods, commas, parentheses, quotes, etc.

For example, using the sentence:

Now is the time for all good men to come to the aid of their[HRT] country.

where [HRT] symbolically represents a carriage return, the tokenizer engine 106 would return the following tokens and token types, on successive calls:

“Now” (word)

““ (whitespace)

“is” (word)

““ (whitespace)

“the” (word)

. . .

“[HRT]” (whitespace)

“country” (word)

“.” (special)

The markup engine 108 itself is implemented as a finite state machine. A finite state machine is a computing function that consists of a set of states (including the initial state), a set of input events, a set of output events and a state transition function. The state transition function takes the current state and an input event and returns the next state and optionally one or more output events. Some states may be designated as “terminal states”. For example, an automatic teller machine may have a “waiting” state that undergoes a transition to a “PIN entry” state upon the receipt (input) of a client's bank card. Upon entry of a correct PIN, the teller machine displays a menu of services (output) and undergoes a state transition to a “receive menu selection” state. If a correct pin is not entered, the teller machine may retain the card and return to its “waiting” state. In the “receive menu selection” state, upon receipt of an input corresponding to a cash withdrawal request, the teller machine undergoes a transition to a “withdraw cash” state, and so on.

The markup engine 108 uses the following variables:

FullMatch will contain text that successfully matches text in the keyphrase file that is mapped to a non-zero value.

PartialMatch contains the text that successfully matches text in the keyphrase file that is mapped to a zero value.

NotYetMatch will contain text obtained from the tokenizer, which has not yet matched anything in the keyphrase file. This is typically the whitespace after a word that has matched.

WordAccum will contain a space-separated list of words that have successfully matched a phrase in the keyphrase file. This is a variable that is internal (local) to the markup engine 108, and used in individual attempted match iterations.

MarkedUpText will contain the marked-up content (that is, the output from the markup engine 108), growing in length as more content on the page is marked up. This is the primary output from the markup engine 108.

LastValue will contain the value from the keyphrase file resulting from the last successful match. This can either be a “0” (last match was on the way towards a full match) or a number>0, indicating a fill match was just reached.

BestValue will contain the maximum lastValue encountered until a mismatch is seen. This allows the algorithm to back up to the last full match.

Hits will contain an accumulated list of BestValues. Hits is provided as an output from the markup engine 108 at the completion of the markup process. This variable can be used to identify all the keyphrases in a particular information resource.

The state diagram of the markup engine 108 is shown in FIG. 4. The markup engine has three states, as follows. Note that in the description of the markup engine 108, “word” is generally used to denote a type of token.

LOOKING state 302—The markup engine 108 is determining whether a token received from the tokenizer engine 106 matches an entry in the processed keyphrase file 105. The received token can either be a word, a whitespace or a special token. Alternatively, the markup engine 108 could receive an indication that there are no more tokens.

EXPANDING_SAW_WORD state 304—a word has matched a phrase in the processed keyphrase file 105, either with or without the WordAccum appended as a prefix to the left of the word. The markup engine 108 should now receive a token that is either of the type “special” or “whitespace.” The markup engine 108 cannot immediately receive another word since two words without an intermediate special token or whitespace token would simply be a long word. Alternatively, the markup engine 108 could receive an indication that there are no more tokens.

EXPANDING_SAW_WHITESPACE state 306—This state is entered after a word has matched a phrase in the processed keyphrase file 105 (in EXPANDING_SAW_WORD 304) and a whitespace token has been seen. The markup engine 108 should now receive a token that is either of the type “special” or “word.” The markup engine 108 cannot immediately receive another whitespace since two whitespaces without an intermediate special token or word token would simply be a long whitespace. Alternatively, the markup engine 108 could receive an indication that there are no more tokens.

The system starts 310 in the LOOKING state 302, with all variables having null values. The markup engine 108 calls for a token from the tokenizer engine 106. Transition 311 occurs as follows: If the received token is a whitespace token or a special token, it is appended to MarkedUpText, and the markup engine 108 returns to the LOOKING state 302 and the markup engine 108 calls for another token. If the received token is a word, then a lookup is performed on the keyphrase file. If the lookup fails to match the received token to an entry in the keyphrase file, the received token is appended to MarkedUpText and the markup engine 108 returns to the LOOKING state 302.

Transition 312 occurs if the received token in the LOOKING state 302 is a word that matches an entry in the keyphrase file. Then the markup engine 108 sets LastValue equal to the value of the phrase ID corresponding to the matched entry. Also, BestValue is set equal to LastValue. If the match is a complete match (that is, the phrase ID is greater than zero), then the token is appended to the text in the FullMatch variable. If the match is not a complete match (that is, the phrase ID is equal to zero), the token is appended to the text in the PartialMatch variable. Finally, irrespective of the value of the phrase ID, the token is added to the text in the WordAccum variable and the markup engine 108 transitions to the EXPANDING_SAW_WORD state 304.

Transition 313 occurs when the markup engine 108 is in the EXPANDING_SAW_WORD state 304, a token has been called from the tokenizer engine 106, and the token that is received from the tokenizer engine 106 is a special token. If BestValue=0 (i.e. the best match seen was only a partial match), then the contents of the PartialMatch variable and the special token are appended to the contents of the MarkedUpText variable. If BestValue>0 (i.e. the best match seen was a complete match), then the contents of the FullMatch variable are converted to an inserted user-selectable object. The inserted user-selectable object is appended to the contents of the MarkedUpText variable, then any remaining text in the PartialMatch variable is added to the contents of the MarkedUpText variable and the value of the BestValue variable is inserted in the Hits variable. All the variables except MarkedUpText and Hits are then reset and the markup engine 108 returns to the LOOKING state 302.

Transition 315 occurs when the markup engine 108 is in the EXPANDING_SAW_WORD state 304, a token has been called from the tokenizer engine 106, and the token that is received from the tokenizer engine 106 is a whitespace token. The whitespace token is appended to the text in the NotYetMatch variable, and the markup engine 108 transitions into the EXPANDING-SAW-WHITESPACE state.

Transition 314 is used to attempt to extend the match. Transition 314 occurs when the markup engine 108 is in the EXPANDING-SAW-WHITESPACE state, a word token is received from the tokenizer engine 106 in response to a call, and a phrase matches a phrase in the keyphrase file.

If the value of the phrase ID of the matched phrase in the keyphrase file is greater than zero (i.e. a complete match), then PartialMatch, NotYetMatch and the current word token are appended to the contents of the FullMatch variable, the value of LastValue is set to the value of the current match and the value of BestValue is set to the value of the current match. The value of BestValue is then added to the contents of the Hits variable.

If the value of the phrase ID of the matched phrase in the keyphrase file is equal to zero (i.e. a partial match) and the value of LastValue=0, then only the NotYetMatch and the word token are added to the PartialMatch variable. The NotYetMatch variable is then set to null.

In either of these two cases, the received token is added to WordAccum with an intervening space, and the markup engine 108 transitions to the EXPANDING-SAW-WORD state.

Transition 316 occurs when the markup engine 108 is in the EXPANDING_SAW_WHITESPACE state 306, a token has been called from the tokenizer engine 106, and the token that is received from the tokenizer engine 106 is a special token. If BestValue=0 (i.e. there was no full match in this iteration) then PartialMatch, NotYetMatch and the received token are appended to MarkedUpText. If BestValue>0 (i.e. there was a complete match this iteration), then the contents of the FullMatch variable are converted to a user-selectable object, the user-selectable object is appended to the contents of the MarkedUpText variable, any remaining PartialMatch contents are added, followed by the contents of NotYetMatch and the received special token. The value of BestValue is then added to the contents of the Hits variable. All the variables except MarkedUpText and Hits are then reset and the markup engine 108 returns to the LOOKING state 302

Before transition 317 is discussed, the concept of “pushback” should be noted. Consider a dictionary that includes the keyphrases “to arrive at the front” and “beach.” A partial match of “to arrive at the beach” will fail the test for “to arrive at the front” after being a partial match at “to arrive at the.” If the markup engine 108 now reverts to the LOOKING state 302 and calls the next token directly from the tokenizer engine 106, the markup engine 108 will miss the keyphrase “beach” in the rejected phrase. Accordingly, this problem can be solved by “pushing back” tokens that might be matches into a last-in-first-out stack comprising tokens that have not themselves been checked individually. When the markup engine 108 calls for a token and the stack is not empty, the next token is provided to the markup engine 108 from the stack and not directly from the tokenizer engine 106. The phrase “receives a token from the tokenizer engine” is to be given a correspondingly broad interpretation that includes such indirect reception. Of course, if the stack is empty, the next token is provided from the tokenizer engine 106 and not from the stack. In particular implementations of the tokenizer engine 106 and the markup engine 108, the maximum number of tokens pushed back into the stack can be varied from none to any selected number, depending on the preference of the contextual mark-up system operator. The number of tokens pushed back may, for example, depend on the processing power of the computer running the contextual mark-up system, which will directly affect the speed at which the converted information resource is delivered to the computing device. Also, the number of tokens pushed back could be varied automatically depending on the demand on the contextual mark-up system.

Alternatively, the contextual commerce system 14 could be configured to push back all of the tokens in a failed partial match. Applicants have selected to push back only one token in any failed partial match, to provide some pushback functionality without compromising processing speed at current computer processing levels. In the above example, the pushback will form the following single-token stack: beach (word). In any configuration, the stack will be read until depleted, after which calls for tokens will be fulfilled from the tokenizer engine 106.

Transition 317 occurs when the markup engine 108 is in the XPANDING_SAW_WHITESPACE state 306, a token has been called from the tokenizer engine 106, and the token that is received from the tokenizer engine 106 is a word token that results in a failed match. In response, the token is pushed into the stack. If the NotYetMatch variable has a non-zero length value, then that is pushed back next. If BestValue=0 (i.e. there was no complete match), then the contents of the PartialMatch variable are appended to the MarkedUpText variable. If BestValue>0 (i.e. the best match seen was a complete match), then the contents of the FullMatch variable are converted to an inserted user-selectable object. The inserted user-selectable object is appended to the contents of the MarkedUpText variable. Any remaining text in the PartialMatch variable is added to the contents of the MarkedUpText variable and the value of BestValue is added to the contents of the Hits variable. All the variables except MarkedUpText and Hits) are then reset and the markup engine 108 returns to the LOOKING state 302.

Finally, when there are no more tokens available, markup engine 108 enters a Final Processing state 320. This state is needed because there may be tokens left over in the PartialMatch and FullMatch variables that need to be processed. If BestValue=0 (i.e. there was no complete match), then the contents of the PartialMatch variable followed by the NotYetMatch variable are appended to the MarkedUpText variable. If BestValue>0 (i.e. the best match seen was a complete match), then the contents of the FullMatch variable are converted to an inserted user-selectable object. The inserted user-selectable object is appended to the contents of the MarkedUpText variable. Any remaining text in the PartialMatch variable followed by the NotYetMatch variable is added to the contents of the MarkedUpText variable, and the value of BestValue is then added to the contents of the Hits variable.

When the markup engine 108 completes its processing 322, the marked up text remains in the variable MarkedUpText and a list of matched keyphrase IDs is contained in the Hits variable. If an entire information resource has passed through the markup engine 108, the contents of the MarkedUpText variable can then be transmitted directly to the computing device 12 where it will be displayed by the Internet browser 36 as a converted information resource. Alternatively, if only a portion of the information resource has been converted, the contents of the MarkedUpText variable replaces the original portion of the information resource that was originally provided to the tokenizer engine 106 for processing. The resulting converted information resource is then transmitted to the computing device 12 where it will be displayed by the Internet browser 36 as a converted information resource. The contents of the Hits variable can easily be used to create a list of matched keyphrases, which can be compared with the keyphrase file to refine the keyphrase file over time. For example, if a keyphrase is rarely found, it might be eliminated from the keyphrase file. Both the Hits and the MarkedUpText variables can also be saved to a storage medium for further review. The contents of all the variables, including the MarkedUpText and Hits variables, are cleared when the tokenizer and markup engine 108 are invoked again.

In the preferred embodiment of the invention, the conversion of a keyphrase with non-zero keyphrase ID into an inserted user selectable object within the markup engine takes place by the replacement of the keyphrase with a URL. The URL is shown generally as follows, where “keyphrase” represents the text of the keyphrase, and “keyphrase ID” is the numerical keyphrase ID for the particular keyphrase ID, and “domain” represents the domain name of the website. As previously indicated, the web site may be a content web site 16 or a commerce web site 18.

A HREF=“https://www.domain.com/lookup?phrasekey=keyphrase ID”
Target=“mall”><font color=“#007700”>keyphrase</font></A>

Using the exemplary processed keyphrase file above, the phrase “to come to the front” in an information resource would be replaced with the URL:

A HREF=“https://www.domain.com/lookup?phrasekey=4”
Target=“mall”><font color=“#007700”>to come to the front</font></A>

As previously indicated, the URL need not include a keyphrase. Instead, the URL may simply specify a web site with potentially relevant content or commerce information.

The configuration file 110 is used to initialize the contextual mark-up system 14. The configuration file may include a list of Internet sites that will be accessed through the contextual mark-up system 14, the paths (locations) at those sites where the information resources are located, and the type of information resource that will be processed. In addition, the configuration file may include definitions of where in the information resources the markup engine 108 will be turned on and off and templates for executing searches at web sites. Further, the configuration file may include a template used by the markup engine for inserting user-selectable objects into an information resource and the location of the processed keyphrase file 105. An abbreviated example of a configuration file is shown below:

```
# Configuration file for Contextual Commerce Proxy
# ContentsSites is a comma-separated list of sites to process
ContentSites: Patents, PubMed, Wiley
### Patents
Patents.site: host=164.195.100.11 \
  & path=*netacgi/nph-Parser* \
  & content-type˜text/html
```

| | |
|---|---|
| Patents.on: | <center><b><i> Description</b></i> |
| Patents.off: | <center><b>* * * * *</b></center> |

```
### PubMed
PubMed.site: host=www.ncbi.nlm.nih.gov \
  & query=*PubMed* \
  & content-type˜text/html
```

| | |
|---|---|
| PubMed.on: | <dl> |
| PubMed.off: | </dl> |
| ### Wiley | |

Wiley.site: (host=www.wiley.com|host=wiley.com) \
& path=/cp/cp* & content-type˜text/html

| | |
|---|---|
| Wiley.on: | <i>Materials</i> |
| Wiley.off: | </html> |

#Supplies URL
SuppliesURL: https://sahara.biospace.com/idev_cybermall/plsql
#Template link to product search in e-commerce system
Template: $SuppliesURL$/srprdpdl?v_phrase_key
ReplacementTemplate: <A HREF=“$Template$=$DictionaryKey$”
Target=“mall”><font color=“#007700”>$OriginalContent$</font></A>
# Link to Window in Supplies showing products found in page
ContextualCommerceURL: $SuppliesURL$/fitsum?v_phrase_key_list
#File containing processed keyphases
keyphrases.properties: /export/home/adam/ship/keyphrases.properties

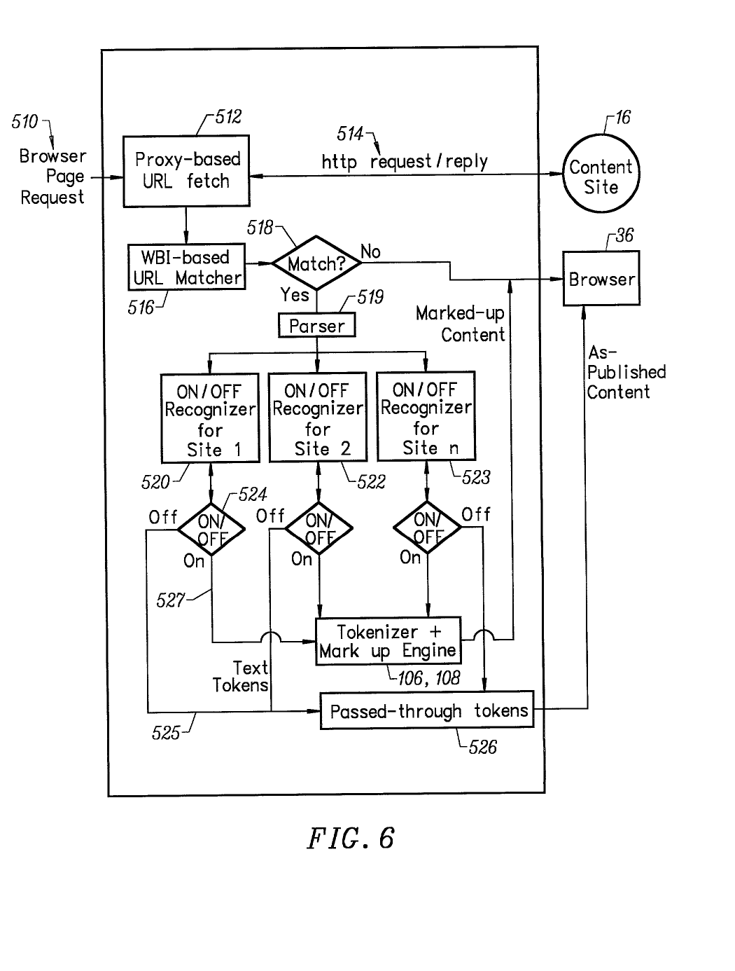

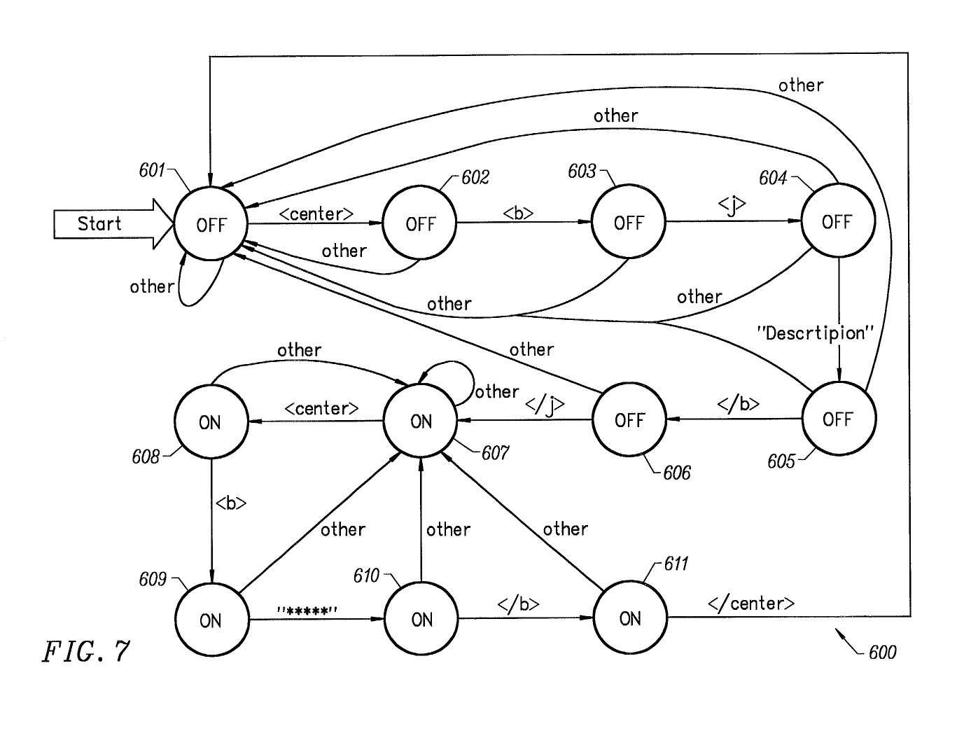

For the “Patents” definition above, the host is defined to be at the IP address 164.195.100.11, the contextual mark-up system 14 is applied to text or HTML information resources that have “netacgi/nph-Parser” in their URL's (“*” being a wildcard). The markup engine is activated after “<center><b><i> Description</b></i>” in the information resource, and is deactivated at “<center><b>* * * * *</b></center>” in the information resource. The ability to activate and deactivate the markup engine is described in more detail below with reference to FIGS. 6 and 7.

The contextual mark-up system 14 of the embodiment of FIG. 3 also includes related modules such as the Internet connectivity module 112 that provides the link between the service 14 and the Internet, as well as the WBI toolkit 114 for writing and maintaining the WBI proxy service. Additional modules that are related to the contextual mark-up system 14 include a makefile module (not shown) and a loader module (not shown). The makefile module is used to keep files that are dependent on each other updated. For example, when the keyphrase file 102 is updated, the makefile module will ensure that the processed keyphrase file 105 is updated by running the keyphrase file processor. The loader module loads the processed keyphrase file into WBI framework. These and other ancillary modules are well known to those of ordinary skill in the art, and will not be discussed further here.

When the converted information resource is received at the computing device 12, it is displayed to the user. As mentioned above, the inserted user-selectable objects are preferably identifiable in some way to allow the user to distinguish them from user-selectable objects that were present in the information resource prior to conversion. In the preferred embodiment, the user-selectable objects that were inserted by the contextual commerce system comprise hyperlinked text that is colored differently from pre-existing hyperlinks. Other methods of identifying the inserted user-selectable objects are by italicizing, highlighting, bolding, enlarging, or providing associated graphics.

Upon receipt of the converted information resource at the computing device 12, the user is free to take the usual actions associated with the information resource. For example, the user may print the information resource, save it, or navigate away from it in a conventional manner. However, should the user select one of the inserted user-selectable objects, the Internet browser will take the action associated with this selection and transmit the associated link to the designated web site.

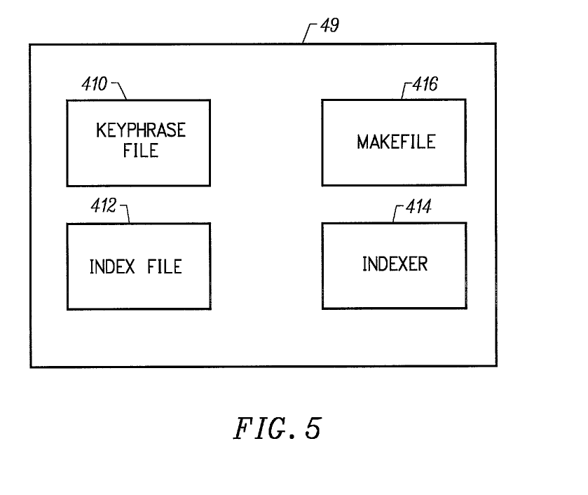

FIG. 1 illustrates that the content web site 16 and the commerce web site 18 each include a contextual mark-up module. FIG. 5 illustrates an embodiment of the contextual mark-up module 49. In this embodiment, the module 49 comprises a keyphrase file 410 of keyphrase IDs versus keyphrases; an index file 412 of keywords versus related content (e.g., related articles or related product or service descriptions), an indexer 414 for generating the index file 412, and a makefile module 416.

To create the index file 412, the indexer 414 scans related resources at the site. In the case of a content site, related content is scanned. In the case of a commerce site, product and service descriptions are scanned (e.g., in the database 46). Thereafter, the indexer 414 creates a list of words found in those descriptions, and, for each word, creates a list of descriptions in which that word is found.

The makefile module 416 contains the location of the keyphrase file 410, the index file 412 and the associated dependencies to propagate changes in the keyphrase and index files. The keyphrase file is obtained from the contextual mark-up system 14, and its location is therefore typically a URL or FTP address at the contextual mark-up system 14. Also included with the commerce module 49 is a loader script.

The keyphrase file 410 is identical to the keyphrase file 102 of the contextual mark-up system 14. The keyphrase file 410 is used to look up a keyphrase when a keyphrase ID is received in a URL that has been sent from the computing device 12. Upon receipt of the URL, the keyphrase ID is extracted and the corresponding keyphrase identified. The contextual mark-up module 49 then initiates a search at the site. At a content site the keyphrase is used to search content. At a commerce site a search is performed in connection with the product and service database 46.

The search using the keyphrase is executed using the index file 412 as follows. First, the keyphrase is parsed into its component words. If the keyphrase is only one word, the corresponding information (i.e., content and/or products and services) is looked up directly from the index file 412. If the keyphrase file is more than one word long, the corresponding information is looked up for each of the component words. The resulting groups of information then undergoes the Boolean operator “AND” to identify information that includes all of the component words. The information that has all the component words of the keyphrase therein is then scanned individually to identify those component words that include the keyphrase itself (i.e. the component words in the correct order).

The information identified is then returned to the computing device 12 in a summary form. The information is presented as a ranked list. The list is displayed on the computing device 12. In the case of content, the user can link to the content for a full description. In the case of a product or service, the user can select a listed product or service to receive the complete product or service description. The transaction service 48 may then be used to place the selected product or service into an online “shopping basket.” Thereafter, the user can proceed to a secure electronic checkout to place an order for the selected products or services.

In one embodiment of the invention, the contextual mark-up system 14 and the site with a contextual mark-up module 49 are owned and run by the same entity. In such a case, one has a completely integrated system. This provides the advantage that control is centralized. Another advantage of this integrated approach is that certain components of the services may be integrated. For example, one configuration file may be provided that serves both the contextual mark-up system 14 and the commerce module 49, and makefile and loader scripts may be provided to keep the files current and loaded.

In the case of a commerce site, the provider of the commerce website 18 need not perform the order fulfillment process. The commerce website 18 can receive an order for a product or service, and this order can be relayed to the vendor of the goods or services. The relaying of the order may be done in any number of ways (fax, mail, telephone messaging, automatic electronic transmission, and the like), but is easily implemented by sending an email to the vendor stating that an order has been placed. The vendor can then login to the commerce site 18 to get the details of the order, which can then be entered into the vendor's order fulfillment system. Order status can be provided to the user by including a link to the vendor's website, or the vendor can login and update an order status field in the transaction service 48. In such a case, the entity running the combined contextual mark-up system 14 and commerce website may receive a commission on each completed commercial transaction.

The contextual mark-up system 14 may be operated by a different entity from the commerce website 18. This approach has the advantage that the product database does not have to be maintained or processed by the provider of the contextual mark-up system 14. This approach has the disadvantages that the commerce website has to be modified to include the contextual commerce module 49 and that the keyphrase file needs to be provided to the commerce website 18 from the contextual mark-up system 14. Altering the inserted user-selectable object can solve these disadvantages. For example, if the format of the URL used to execute a search at a particular commerce site is known, a template can be created from the format. The keyphrase itself (and not the keyphrase ID) is inserted as the search term into the template by the markup engine 108, thereby providing a URL that will be recognized by the commerce site 18. When this URL is received at the commerce site 18 in response to a selection, a conventional search is executed at the commerce site 18 and conventional search results are provided to the computing device 12. The user can then browse the search results and select products or services as before. In such a case, the contextual commerce provider is again remunerated on a commission basis. The identity of the contextual commerce provider can be relayed to the commerce website 18 by embedding an identifier in the inserted user-selectable object. Alternatively, other techniques can be used to identify the contextual commerce site, such as by the use of cookies.

In a further alternative embodiment, the contextual mark-up system 14 is provided as an application running on the computing device 12. In such a case, the user is provided with updated keyphrase files 102 and configuration files 110 from the provider of the application. The provider of the application may be remunerated on a commission basis by embedding an identifier in a URL that is returned to the commerce site 18. Of course, in such a case the commerce website 18 would not be provided with the contextual commerce module 49, and the format of the URL for searching the commerce site would need to be provided in the configuration file.

In another alternative embodiment, the contextual mark-up system is run by the content website 16. In this case, the functioning of the contextual mark-up system is substantially the same as for the first described embodiment.

In yet another alternative embodiment, the keyphrases that are present in any particular information resource can be gathered together and presented separately from the information resource itself. This can be implemented at the end of the conversion of the information resource by extracting the keyphrase ID's from the “Hits” variable discussed with reference to FIG. 4, converting the keyphrase ID's into keyphrases, sorting them alphabetically, and converting them into user-selectable objects. These can then be presented in a separate window of the Internet browser 36 for user selection. In the preferred version of this alternative embodiment, this is done in conjunction with the presentation of a converted information resource, but it could also be implemented instead of converting the information resource. That is, instead of converting keyphrases into inserted user-selectable objects within the information resource, these keyphrases can be identified and presented in a separate window without making any alterations to the information resource.

Additional information can also be provided in the separate window containing the located keyphrases. For example, an integer number representing the number of hits in the product or service database that would be returned by a selection of that keyphrase could be included.

Further, it will be appreciated that the invention may be used to insert user-selectable objects that result in a search being done through a different collection of information resources (e.g. a separate content website) instead of through a product or service database 46. In such a case, this would be done by including with the different collection of information resources the necessary indexer, index files and keyphrase file as described above with reference to FIG. 5.

Yet further, it will be appreciated that all the methods described herein are typically embodied in program code that is provided in an appropriate medium. For example, the invention may be embodied as program code embodied in an article of manufacturer such as a CD-ROM, hard-drive or other data storage device. Also, the program code may be embodied in random access memory or other volatile or non-volatile computer memory. Further, the program code may be embodied in a carrier wave. Also, it will be appreciated that each computer implemented step is typically embodied in program code. For purposes of conciseness, this has not been recited for each computer-implemented step.

As mentioned briefly above with reference to the configuration file 110, the contextual mark-up system 14 preferably only inserts user-selectable links in a portion of any information resource. This reduces the processing required and provides a uniform presentation across a group of similar information resources. An architecture diagram for accomplishing this is shown in FIG. 6.

First, a request for an information resource that has been rerouted to the contextual mark-up system 14 is received 510. The request is proxied 510 by the web intermediary (WBI), and an HTTP request 514 is made of the content site 16. The requested information resource is returned 514 from the content site 16 in response to the HTTP request. In the described embodiment, the information resource takes the form of an HTTP reply stream. A WBI-based URL matcher is invoked 516 to compare the URL of the information resource to the sets of rules in the configuration file 110 (discussed previously). If the information resource's URL does not match 518 one of the sets of rules, the information resource is returned unmodified to the Internet browser 36. If the information resource's URL does match 518 one of the sets of rules in the configuration file 110, the HTTP reply stream (information resource) is passed through an HTML parser 519 and then to a recognizer module 520, 522 or 523. An HTML parser is available as a helper class from the WBI toolkit, and parses the HTML stream into HTML tokens and text tokens. A text token is a single, undivided text portion between consecutive HTML tokens. Thus, a text token may, for example, be a single word or sequence of characters, or may be pages of uninterrupted (by a HTML token) text.

One recognizer module 520, 522, 523 is provided for each of the content sites 16 listed in the configuration file 110. The recognizer modules 520, 522, 523 each maintain a state variable of ON or OFF 524, depending on what is seen in the HTTP stream passing through the recognizer. When the recognizer module 520 is in the OFF state, HTML tokens and text leave the recognizer module without being marked up, and return 526 as originally published content to the Internet browser 36. When the recognizer module 520 is in the ON state, receipt of a text token (i.e., text between two HTML tokens) results in a call to the tokenizer and markup engines 106, 108, which then mark up the text token as described above with reference to FIGS. 3 and 4. While in the ON state, HTML tokens received by the recognizer module 520 return 526 to the Internet browser 36. That is, only text is passed to the tokenizer and markup engines 106, 108, while HTML tokens bypass 526 the tokenizer and markup engines 106, 108.

The recognizer module 520 thus scans the HTTP stream passing through it and selectively diverts tokens to the tokenizer and markup engines 106, 108. After the text markup is complete, the recognizer module 520 then continues to scan the HTTP stream passing through it, passing any HTML tokens to the Internet browser 36 and text to the tokenizer and markup engines 106, 108. When the recognizer module 520 recognizes a sequence of HTML tokens and/or text characters that have been defined to indicate that marking up of the HTTP stream is to cease, it passes the HTTP stream to the Internet browser without invoking the tokenizer and markup engines 106, 108. The recognizer module 520 continues to scan the HTTP stream until the entire resource has passed through the recognizer module, at which time it can receive another information resource to be scanned.

It should be noted that, while the return of the content to the Internet browser is shown as two paths, this has been done to provide a conceptual understanding of the invention. Both the portions of the information resource that are marked up and those that are not marked up, return in a conventional manner to the Internet browser 36 as an HTML stream. Further, the recognizer modules 520, 522, 523 do not continue processing the received HTML stream when the tokenizer and markup engines 106, 108 have been called to process a text token. Rather, the recognizer modules wait 520, 522, 523 until the tokenizer and markup engines 106, 108 have completed processing the text token before calling for the next token from the HTML parser 519. Thus, the order of the HTML stream is maintained.

While the operation of the recognizer module 520 is described below with reference to a single block of text in an information resource, it will be appreciated that the recognizer module 520 could switch on and off a number of times in any information resource.

One example of a recognizer module 600 for use with content from the USPTO patent database is shown in FIG. 7. Patent descriptions (which have been selected as the portion of interest) in patent records from the USPTO patent database begin when the HTML page contains the tokens:

<center><b><i> Description</b></i>

i.e., when a bold, italicized Description appears. Five asterisks in the center of the page demarcate the end of the description, namely,

<center><b>* * * *</b></center>

While it is true that these sequences of HTML can appear anywhere within the patent's HTML page, it is rare to find this sequence of HTML tokens demarcating anything other than the beginning and end of the patent description.

As mentioned above, markup is only to occur within the “Description” portion of the patent record. Therefore, the recognizer module 600 that has been configured for the USPTO patent database website must be able to recognize the sequences of HTML tokens (defined above) within the HTTP reply stream, and maintain the state of the ON/OFF variable accordingly.

In this embodiment, the recognizer modules 520, 522, 523, 600 are constructed as classical finite state machines (FSMs) that use HTML tokens and text obtained from the HTML parser 519. A specific FSM is constructed for each content site 16 by retrieving the definitions contained in the configuration file 110 that specify when the markup is to occur for the specific content site 16, and constructing an FSM that can recognize when that same stream of tokens passes through the recognizer module.

Referring to FIG. 7, the FSM recognizer module 600, which is configured for patent records from the USPTO patent database, starts off in state 601, which is an OFF state. As a token is received from the HTTP parser 519, the recognizer module 600 then transitions from the one state to the next according to the labeled transitions. Recognizer module 600 remains in state 1 until the first <center> tag is seen, at which time recognizer module transitions into state 602. The only token that can transition the recognizer module 600 into state 602 from state 601 is the <center> token. All other tokens follow the transition labeled “other” that returns the recognizer module 600 back into the OFF state 601. As can be seen from FIG. 7, the only way the recognizer module 600 will transition all the way to the ON state 607 is if it receives the “<center><b><i> Description</b></i>” tokens in the correct order. That is, the recognizer module 600 will transition through the OFF states 602, 603, 604, 605 and 606 and finally, in response to the second “<i>” token, will transition to the ON state 607. If the recognizer module 600 does not receive the correct next token in any of the states 602 to 606, the recognizer module 600 returns to state 601 as shown

As the recognizer module 600 sees tokens that transition it through states 601 to 606, the recognizer module 600 remains in an OFF state, meaning that no markup of the content is performed. Once the </i> token is seen in state 606, the next state is the ON state 607, and each subsequent text token results in a call to the tokenizer and markup engines 106, 108 to mark up the text token. HTML tokens do not result in a call to the tokenizer and markup engines 106, 108 even when the recognizer module is in the ON state.

In state 607, the recognizer module begins the task of looking for the sequence of HTML and text tokens that will end the marking up of the patent record (the information resource) from the USPTO patent database (the collection of information resources). As before, and as can be seen from FIG. 7, the only way the recognizer module will transition from the ON state 607 to the OFF state 601 is if it receives the “<center><b>* * * * *</b></center>” tokens in the correct order. That is, the recognizer module 600 will transition through the ON states 608, 609, 610, and 611 and finally, in response to the “</center>” token while in state 611, will transition to the OFF state 601. If the recognizer module 600 does not receive the correct next token in any of the states 607 to 611, the recognizer module 600 returns to the ON state 607.

As the recognizer module 600 receives tokens that transition it through states 6077 to 611, the recognizer module 600 remains in an ON state, meaning that received text tokens result in calls to the tokenizer and markup engines 106, 108 for markup of the content. Once the </center> token is seen in state 611, the recognizer engine returns to the OFF state 601 (no markup occurring) and the HTML stream is not marked up by the tokenizer and markup engines 106, 108 once again.

The recognizer module 520, 522, 523 for each content site is custom-built using the ON/OFF definitions included in the configuration file 110 to construct an in-memory table with appropriate transitions and state values. The table that corresponds to recognizer module 600 is as follows, noting that the “600” that has been added to the state number herein for the purposes of describing FIG. 7 has been omitted:

| | | Awaiting | Next State if | Next state if |
|---|---|---|---|---|
| State ID | Action | Token | seen | not seen |
| 1 | OFF | <center> | 2 | 1 |
| 2 | OFF | <b> | 3 | 1 |
| 3 | OFF | <i> | 4 | 1 |
| 4 | OFF | “Description” | 5 | 1 |
| 5 | OFF | </b> | 6 | 1 |
| 6 | OFF | </I> | 7 | 1 |
| 7 | ON | <center> | 8 | 7 |
| 8 | ON | <b> | 9 | 7 |
| 9 | ON | “* * * * *” | 10 | 7 |
| 10 | ON | </b> | 11 | 7 |
| 11 | ON | </center> | 1 | 7 |

Constructing the table for each content site 16 involves reading the appropriate line for each content site 16 in the configuration file 110, and using this information to create and add rows to the table. The module that constructs the table reads two strings (one for ON and one for OFF) from the configuration file 110 that define when the recognizer module should transition to the ON and OFF states, and then, from the two strings, adds elements to the table as appropriate. This is done as follows. Using an HTML tokenizer, each HTML token is obtained from a ContentSite.ON variable in the configuration file. For example, considering:

Patents.ON: <center><b><i> Description</b></i>

The string of tokens that would be returned from the HTML Tokenizer is:

<center>, <b>, <i>, “Description”, </b>, </i>

For each token that is read, a row (state) is inserted in the state transition table with a “State ID” that increments from 1, an “Action” of “OFF”, an “Awaiting token” set to the token received from the HTML tokenizer, and “Next State If Not Seen” set to 1. The “Next state if seen” is the value of the state ID plus 1.

As can be seen from the table, the ContentSite.OFF value is then processed in a similar way, except that the “Next state if not seen” value is the State ID of the first state with the ON action, all rows have an “Action” set to “ON,” the “Next state if seen” is the state ID plus one except for the last row/state, and the “Next State if seen” for the last row to is set to 1. This allows the recognizer module to begin again from the initial state in case there are several non-contiguous sections in the HTML that require markup.

The methods described herein have performed well at linking previously unlinked content to other commercial or content sites. Applicants have benchmarked the contextual mark-up system 14 on a Sun Enterprise 450 server, and have demonstrated the ability to markup a 75,000 character HTML page using a 900,000 word dictionary in under 1 second.

The inserted user-selectable objects of the invention provide a user with an enhanced information resource. This enhanced information resource can operate as a building block for additional schemes to improve the manner in which information is presented to a user and is otherwise made accessible to a user. For example, the contextual mark-up system 14 may include a content categorization module 116, as shown in FIG. 3. The content categorization module 116 includes executable code to facilitate the organization of information, for example by rating the quality of information and assigning the information to different content classes. The content categorization module 116 may also be used to facilitate searches of previously organized information and to display search results in such a manner that the user can more readily understand the significance of identified information.

The contextual mark-up system 14 may also include a keyword summary module 118. The keyword summary module 118 provides document summaries according to links within the document. Typically, a user is associated with a user group that has its own keyword ontology or list of relevant keywords. Those keywords that appear in a document are identified in a document summary, as illustrated below.

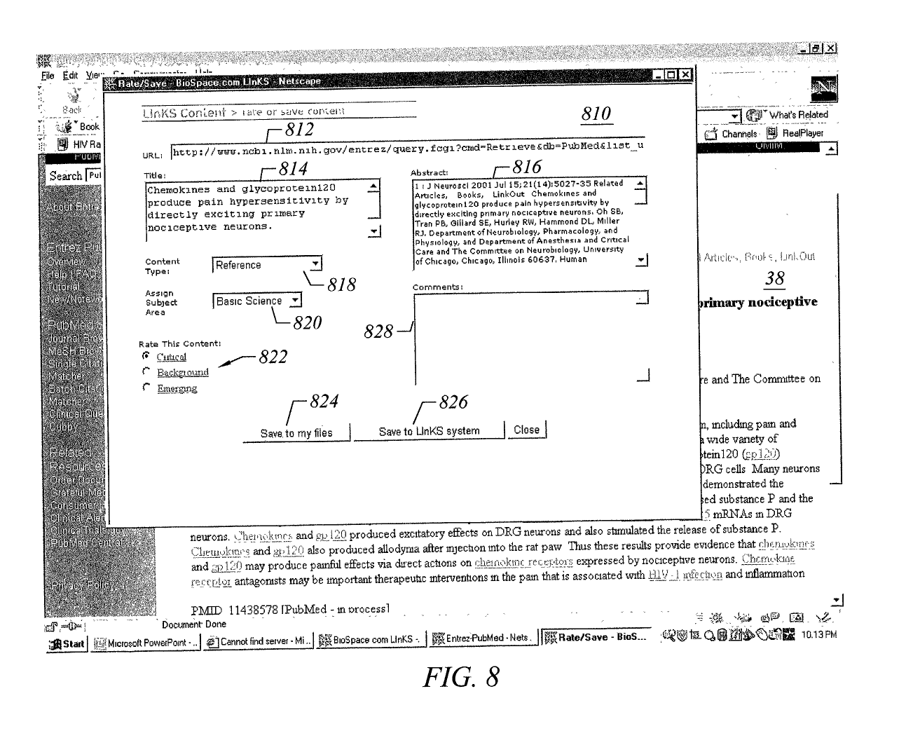

The operation of the content categorization module 116 is more fully appreciated in connection with FIG. 8. FIG. 8 illustrates an information resource 38 retrieved and processed in accordance with the invention, as discussed above. In one embodiment of the invention, the contextual mark-up system 14 modifies the information resource 38 to include an inserted user-selectable object which when selected produces a content categorization window 810. As shown in FIG. 8, the content categorization window 810 includes the network address 812, title 814, and abstract 816 for the information resource.

The content categorization window 810 is also used to obtain content characterization information from a user. The content characterization information can be secured, in one embodiment, through a content type pull-down window 818. By way of example, the content can be categorized as a reference resource, a literature resource, a patent resource, a news resource, and the like. Another form of content characterization information that may be used in accordance with the invention is a subject area pull-down window 820. By way of example, the content can be categorized in different subject matters, such as basic science, biology, oncology, HIV, engineering, and the like. Another form of rating mechanism that may be used in accordance with the invention are radio buttons 822, which can be used to rate content to predefined categories, such as critical, background, or emerging. As shown in FIG. 8, a comment box 828 is preferably provided to allow a user to provide detailed content characterization information.

Once the information resource is rated in accordance with the foregoing techniques, it may be saved as a file accessible solely to the user or as a file accessible to a work group associated with the user. The button 824 is used to save the information resource as a file accessible solely to the user ranking the information resource. The button 826 is used to save the information resource as a file accessible to a work group associated with the user. For example, the work group may be a group of colleagues within the same company or it may be a group with individuals at different companies, universities, and research consortiums that share a common interest. The content categorization module 116 coordinates the storage and organization of this information.

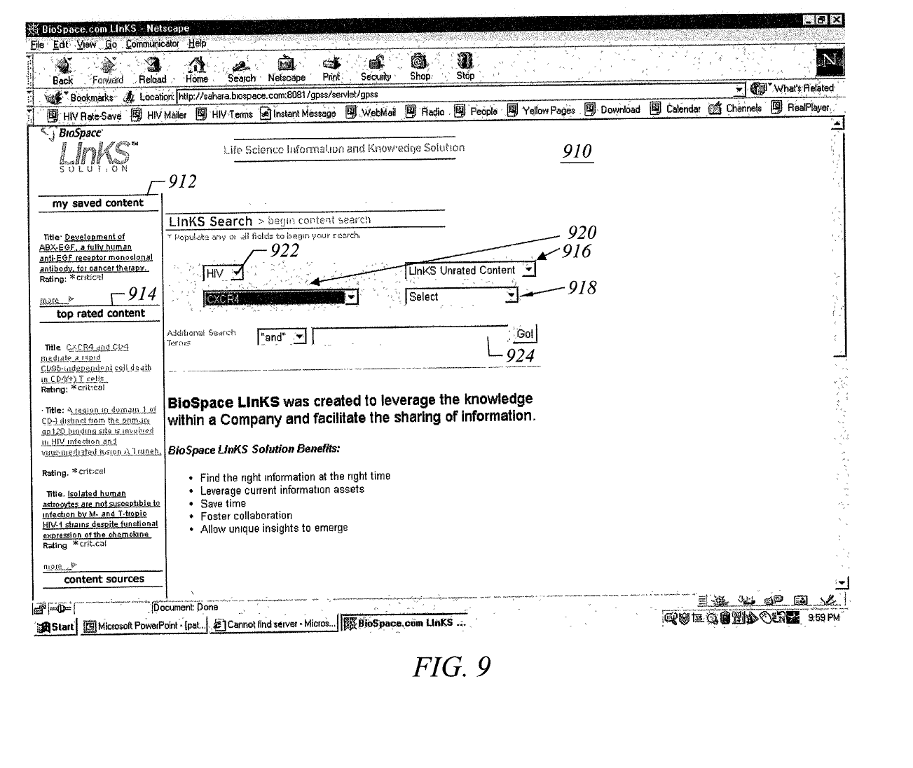

Once information is rated and saved in the manner characterized in connection with FIG. 8, there are new display and search options available for the rated content. FIG. 9 provides an example window 910 that may be used to display and search for rated content. The rated content display window 910 includes a region 912 for displaying the content saved by the user. This content corresponds to content that is saved using the button 824 of FIG. 8. The rated content display window 910 also has a region 914 for identifying top rated content. The top rated content is generally associated with a particular user group. The content categorization module 116 keeps track of all of the rated content and different user groups. Thus, different user groups may have different top rated content. Typically, the rated content is in the form of a set of URLs.

The display window 910 also provides various options for searching rated content. For example, a pull-down menu 916 allows one to search different content areas. These content areas generally correspond to the subject areas associated with pull-down menu 820 of FIG. 8. A content type pull-down menu 918 allows focused searches of content type. The various content types correspond to the options available at pull-down menu 818 of FIG. 8. Additional content search criteria may also be specified. For example, a focus area may be specified with pull-down menu 922. Similarly, a target area may be specified with a pull-down menu 920.

Additional search terms may also be entered in block 924. Execution of a search using criteria of this type fosters the identification of the most relevant information available. For example, in the case of a company that has generated a substantial body of information on a topic, this information can be organized by content type in the manner described, and then be searched in a targeted manner. The window 910 may also be used to search content that is not rated.

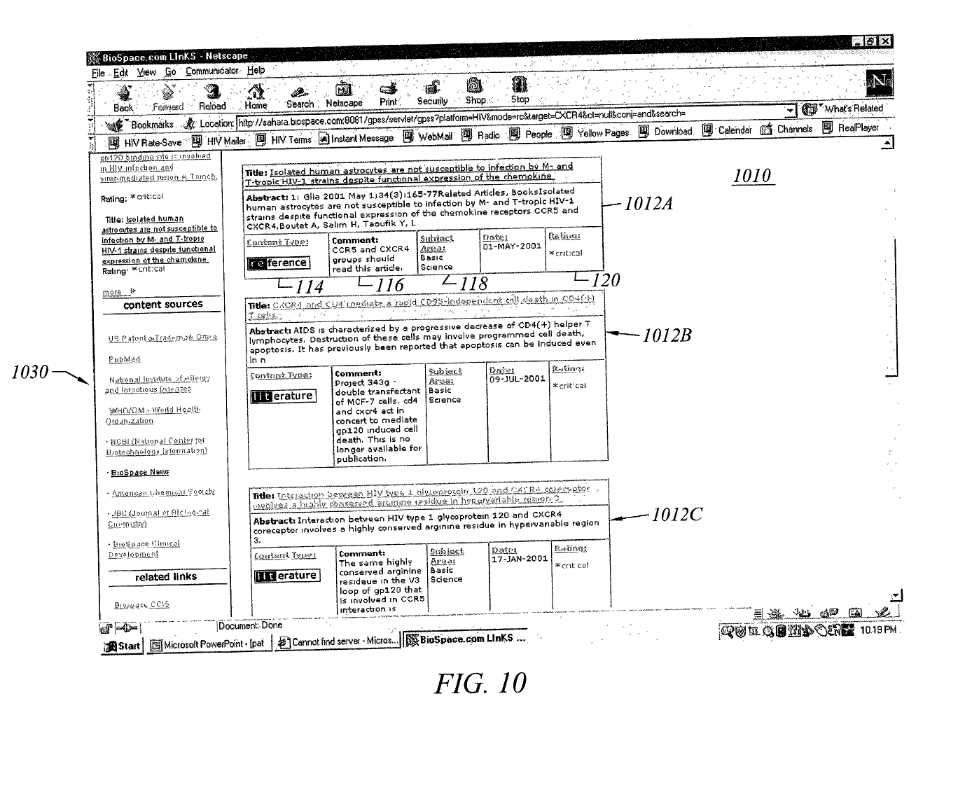

An exemplary display of the results of such a search is shown in FIG. 10. The window 1010 displays three articles 1012A, 1012B, and 1012C identified by a search. Each article has standard information, such as a title and an abstract, but also includes content characterization information. For example, a content type 114 is displayed. This content type corresponds to the content type specified at block 818 of FIG. 8. Comments on the article from an individual within a group are also provided. Recall that block 828 of FIG. 8 allows a user within a group to add comments on a content source that can be subsequently shared within the group.

FIG. 10 also illustrates that a content source can be characterized by subject area 118. This subject area characterization corresponds to the pull-down menu 820 of FIG. 8. In addition, a rating 120 for the content can be provided. This rating 120 corresponds to the different radio buttons 822 displayed in FIG. 8.

FIG. 10 also illustrates that a user within a group may receive information on different content sources available to a group. That is, region 1030 of FIG. 10 illustrates different content sources that are available within a user group.

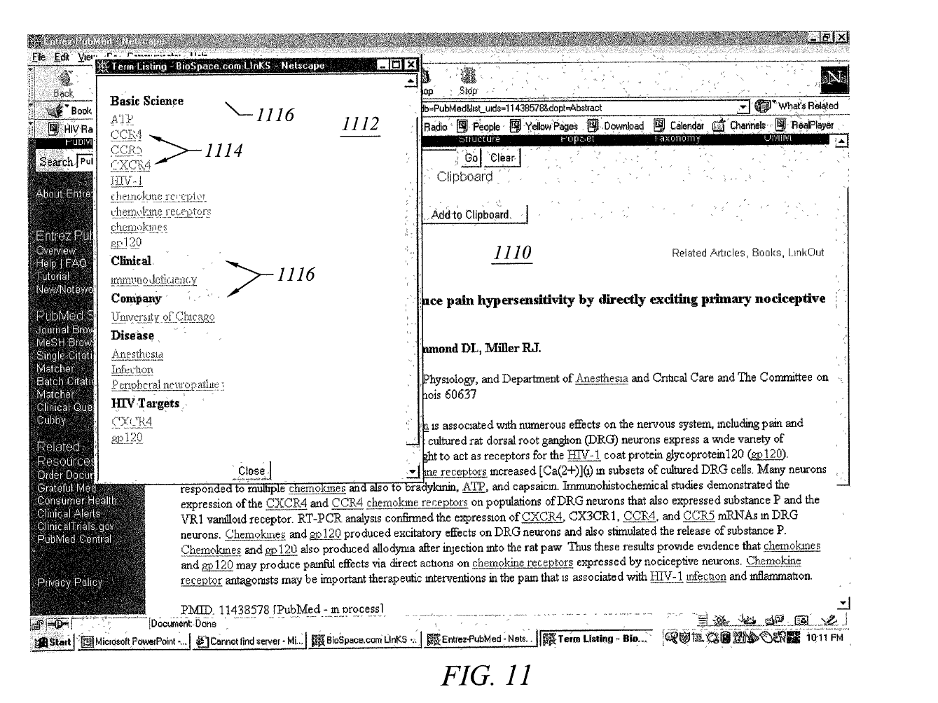

FIG. 11 illustrates another feature of the invention. In one embodiment of the invention, the contextual mark-up system 14 includes a keyword summary module 118. The keyword summary module 118 includes executable code to create a summary of links within an information resource. These links can be grouped into different content areas. For example, FIG. 11 illustrates a delivered information resource 1110. The delivered information resource 1110 may include an inserted user-selectable object that invokes a summary window 1112. That is, in response to selecting the inserted user-selectable object, the keyword summary module 118 generates a summary window 1112 for the delivered information resource 1110.

The document summary window 1112 includes a list of all user-selectable objects 1114 within the resource 1110 that correspond to a predetermined list of keywords. Typically, the keywords would be specific to a particular user group associated with the user. The user-selectable objects 1114 include original user-selectable objects created at the information source and inserted user-selectable objects created in accordance with the invention. The user-selectable objects 1114 can be grouped into different predetermined categories 1116. For example, these categories may be selected using the window 810 of FIG. 8. The categories may also be keywords associated with a particular user group.

The document summary window 1112 provides an efficient way of analyzing significant information within a content resource. The document summary window 1112 allows a user to only focus on key terms of interest and to immediately link to related content by simply selecting an object within the list.

All patents and other references cited herein are incorporated by reference. The foregoing description of a preferred embodiment of the invention has been presented for the purposes of illustration and description. It is not intended to be exhaustive or to limit the invention to the precise form disclosed, and many modifications and variations are possible in light of the above teachings. The particular embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A method of providing contextual marked-up information, comprising
receiving a request from a user for an information resource;
retrieving said information resource;
converting data in said information resource into inserted user-selectable objects, thereby rendering a converted information resource; and
providing said converted information resource to said user.

2. The method of claim 1 wherein said converting includes:
scanning text in said information resource for a selected key phrase; and
replacing said selected key phrase with an inserted user-selectable object.

3. The method of claim 2 wherein said replacing includes replacing said selected key phrase with an inserted user-selectable object in the form of a uniform resource locator.

4. The method of claim 3 wherein said replacing includes replacing said selected key phrase with an inserted user-selectable object in the form of a uniform resource locator with a key phrase identifier.

5. The method of claim 1 wherein converting includes:
parsing a markup language document into markup language tokens and text-only portions;
scanning at least one text-only portion for the presence of a key phrase; and
replacing said key phrase with an inserted user-selectable object.

6. The method of claim 1 further comprising:
obtaining user content characterization information classifying information within said information resource.

7. The method of claim 6 wherein obtaining includes obtaining content characterization information selected from the group including: content type, content subject area, and content comments.

8. The method of claim 1 further comprising:
receiving instructions to store said information resource as saved content associated with said user.

9. The method of claim 1 further comprising:
receiving instructions to store said information resource as saved content associated with a group of individuals that includes said user.

10. The method of claim 9 further comprising:
searching for documents stored by said group.

11. The method of claim 10 wherein searching includes searching for documents stored by said group according to content characterization information specified by said user.

12. The method of claim 11 further comprising:
delivering search results that include content characterization information.

13. The method of claim 1 further comprising:
inserting a document summary user-selectable object into said information resource, said document summary user-selectable object invoking a document summary window that lists predetermined key phrases identified within said information resource.

14. The method of claim 13 wherein inserting includes inserting a document summary user-selectable object into said information resource that invokes a document summary window that lists predetermined key phrases identified within said information resource, wherein said predetermined key phrases are organized in accordance with predetermined content categories.

15. A computer readable medium to direct a computer to function in a specified manner, comprising:
instructions to process a request from a user for an information resource;
instructions to retrieve said information resource;
instructions to convert data in said information resource into inserted user-selectable objects, thereby rendering a converted information resource; and
instructions to provide said converted information resource to said user.

16. The computer readable medium of claim 15 wherein said instructions to convert include:
instructions to scan text in said information resource for a selected key phrase; and
instructions to replace said selected key phrase with an inserted user-selectable object.

17. The computer readable medium of claim 16 wherein said instructions to replace include instructions to replace said selected key phrase with an inserted user-selectable object in the form of a uniform resource locator.

18. The computer readable medium of claim 16 wherein said instructions to replace include instructions to replace said selected key phrase with an inserted user-selectable object in the form of a uniform resource locator with a key phrase identifier.

19. The computer readable medium of claim 15 wherein said instructions to convert include:
instructions to parse a markup language document into markup language tokens and text-only portions;
instructions to scan at least one text-only portion for the presence of a key phrase; and
instructions to replace said key phrase with an inserted user-selectable object.

20. The computer readable medium of claim 15 further comprising:
instructions to obtain user content characterization information classifying information within said information resource.

21. The computer readable medium of claim 20 wherein said instructions to obtain include instructions to obtain content characterization information selected from the group including: content type, content subject area, and content comments.

22. The computer readable medium of claim 15 further comprising:
instructions to store said information resource as saved content associated with said user.

23. The computer readable medium of claim 15 further comprising:
instructions to store said information resource as saved content associated with a group of individuals that includes said user.

24. The computer readable medium of claim 23 further comprising:
instructions to search for documents stored by said group.

25. The computer readable medium of claim 24 further comprising:
instructions to search for documents stored by said group according to content characterization information specified by said user.

26. The computer readable medium of claim 25 further comprising:
instructions to deliver search results that include content characterization information.

27. The computer readable medium of claim 15 further comprising:
instructions to insert a document summary user-selectable object into said information resource, said document summary user-selectable object invoking a document summary window that lists predetermined key phrases identified within said information resource.

28. The computer readable medium of claim 27 further comprising:
instructions to invoke a document summary window that lists predetermined key phrases identified within said information resource, wherein said predetermined key phrases are organized in accordance wit h pre determined content categories.
